(19) United States
(12) Patent Application Publication
(10) Pub. No.: US 2008/0190543 A1
(43) Pub. Date: Aug. 14, 2008

(54) Apparatus For and Method of Manufacturing Photosensitive Laminated Bod

(75) Inventors: Kazuyoshi Suehara, Shizuoka-ken (JP); Nobuyasu Akiyoshi, Shizuoka-ken (JP); Kenichi Imoto, Shizuoka-ken (JP); Ryo Mori, Shizuoka-ken (JP); Chiaki Suzuki, Kanagawa-ken (JP); Ryoichi Sugihara, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Tokyo (JP)

(21) Appl. No.: 11/631,593

(22) PCT Filed: Jul. 6, 2005
(86) PCT No.: PCT/JP05/12872

§ 371 Date: Dec. 13, 2007

(30) Foreign Application Priority Data
Jul. 6, 2004 (JP) 2004-199892
Aug. 25, 2004 (JP) 2004-245840

(51) Int. Cl. B32B 38/18

(52) U.S. Cl. 156/64; 156/350

(57) ABSTRACT

A manufacturing apparatus (20) has a reel-out mechanism (32), a processing mechanism (36), a label bonding mechanism (40), a reservoir mechanism (42), a peeling mechanism (44), a substrate feed mechanism (45), and a joining mechanism (46). A detecting mechanism (47) for directly detecting a boundary position of a photosensitive web (22) is disposed upstream of and closely to the joining mechanism (46). Based on detected information from the detecting mechanism (47), a relative position of the boundary position and a substrate (24) in a joining position is adjusted.

### TECHNICAL FIELD

The present invention relates to an apparatus for and a method of manufacturing a photosensitive laminated body by delivering two or more elongate photosensitive webs each comprising a photosensitive material layer and a protective film that are successively deposited on a support, peeling off the protective films to expose the photosensitive material layers, and joining the exposed photosensitive material layers parallel to each other to substrates.

### BACKGROUND ART

Substrates for liquid crystal panels, substrates for printed wiring boards, and substrates for PDP panels, for example, have a photosensitive sheet (photosensitive web) having a photosensitive material (photosensitive resin) layer and applied to a substrate surface. The photosensitive sheet comprises a photosensitive material layer and a protective film that are successively deposited on a flexible plastic support.

An applying apparatus for applying such a photosensitive sheet usually operates to feed substrates such as glass substrates, resin substrates, or the like at predetermined intervals, and peel off the protective film from the photosensitive sheet for a length corresponding to the range of the photosensitive material layer that is to be applied to each of the substrates.

According to a method of and an apparatus for applying a film as disclosed in Japanese Laid-Open Patent Publication No. 11-34280, for example, as shown in FIG. 32 of the accompanying drawings, a laminated film la unreeled from a film roll 1 is trained around guide rolls 2a, 2b and extends along a horizontal film feed plane. The guide roll 2b is combined with a rotary encoder 3 for outputting as many pulses as depending on the length by which the laminated film la is fed.

The laminated film la that extends along the horizontal film feed plane from the guide rollers 2a, 2b is trained around a suction roll 4. A partial cutter 5 and a cover film peeler 6 are disposed along the horizontal film feed plane between the guide roll 2b and the suction roll 4.

The partial cutter 5 has a pair of disk cutters 5a, 5b. The disk cutters 5a, 5b are movable transversely across the laminated film 1a to cut off a cover film (not shown) of the laminated film 1a together with a photosensitive resin layer (not shown) on the reverse side of the cover film.

The cover film peeler 6 presses a sticky tape 7a unreeled from a sticky tape roll 7 strongly against the cover film between presser rollers 8a, 8b, and then winds up the sticky tape 7a around a takeup roll 9. The cover film is peeled off from the photosensitive resin layer by the sticky tape 7a, and wound together with the sticky tape 7a around the takeup roll 9.

The suction roll 4 is followed downstream by a pair of lamination rolls 12a, 12b for superposing and pressing the laminated film 1a against upper surfaces of a plurality of substrates 11 which are successively intermittently fed by a substrate feeder 10. A support film takeup roll 13 is disposed downstream of the lamination rolls 12a, 12b. Light-transmissive support films (not shown) applied to the respective substrates 11 are peeled off and wound up by the support film takeup roll 13.

In the above conventional art, measuring the number of pulses generated by the rotary encoder 3 is started when the partial cutter 5 starts cutting the laminated film 1a. When the measured value of the pulses from the rotary encoder 3 reaches the value corresponding to the predetermined position to be cut on the laminated film 1a, the substrate feeder 10 is actuated. Thus, the substrates 11 are fed synchronously with the laminated film 1a between the lamination rolls 12a, 12b. In this way, the laminated film 1a is positioned for being applied to each of the substrates 11.

In the conventional art, measuring the number of pulses generated by the rotary encoder 3 on the guide roll 2b is started when the partial cutter 5 starts cutting. The substrates 11 are fed such that the partly cut region is considered to reach a predetermined position between the lamination rolls 12a, 12b, based on the measured value.

In this case, however, the length between the partial cutter 5 and the lamination rolls 12a, 12b is considerably large. Thus, the length of the laminated film 1a may vary due to the heat from lamination units, or the rotary encoder 3 may suffer from slippage. Thus, it is impossible to accurately position the laminated film 1a and the substrates 11 with respect to the lamination rolls 12a, 12b.

### DISCLOSURE OF INVENTION

It is a major object of the present invention to provide an apparatus for and a method of manufacturing a high-quality photosensitive laminated body, by accurately joining an elongate photosensitive web to substrates through a simple process and arrangement.

According to the present invention, there is provided an apparatus for manufacturing a photosensitive laminated body, comprising a web reel-out mechanism for reeling out an elongate photosensitive web comprising a support, a photosensitive material layer disposed on the support, and a protective film disposed on the photosensitive material layer, the protective film having a peel-off section and a residual section; a processing mechanism for forming a processed region which is transversely severable in the protective film of the elongate photosensitive web which has been reeled out by the web reel-out mechanism, at a boundary position between the peel-off section and the residual section; a peeling mechanism for peeling the peel-off section off from the elongate photosensitive web, leaving the residual section; a substrate feed mechanism for feeding a substrate which has been heated to a predetermined temperature to a joining position; a joining mechanism for positioning the residual section between the substrates and joining an exposed area of the photosensitive material layer from which the peel-off section is peeled off, to the substrate in the joining position, for producing a joined substrate; a detecting mechanism disposed closely to the joining position, for directly detecting the boundary position of the elongate photosensitive web or a detecting mark disposed on the elongate photosensitive web in association with the boundary position; and a control mechanism for adjusting a relative position of the boundary position and the substrate in the joining position, based on boundary position information detected by the detecting mechanism.

The detecting mechanism should preferably be disposed upstream of and closely to the joining position because the relative position of the elongate photosensitive web and the substrate can be adjusted under simple control.

Reservoir mechanism should preferably be disposed between the processing mechanism and the peeling mechanism, for changing speed or state at which the elongate photosensitive web is fed. Therefore, the elongate photosensitive web is fed intermittently through the processing mechanism, and thereafter fed continuously through the reservoir mechanism in the peeling mechanism and subsequently thereto.

Furthermore, a tension control mechanism should preferably be disposed between the peeling mechanism and the joining mechanism, for applying tension to the elongate photosensitive web. Consequently, the elongate photosensitive web can be adjusted for stretching, allowing the boundary position to be adjusted easily into alignment with the joining position.

Furthermore, a cutting mechanism should preferably be disposed downstream of the joining mechanism, for cutting off the elongate photosensitive web between the substrates.

A support peeling mechanism should preferably be disposed downstream of the joining mechanism, for peeling the support off from joined substrates. The support may automatically be peeled off after being cut to lengths corresponding to respective substrates, or may continuously be wound so as to be peeled off automatically.

The joining mechanism should preferably comprise a pair of rubber rollers which can be heated to a predetermined temperature, and a roller clamp unit for moving one of the rubber rollers back and forth. The roller clamp unit should preferably comprise a cylinder for applying a clamping pressure to the one of the rubber rollers, and a cam movable by an actuator for moving the cylinder back and forth.

A preheating unit should preferably be disposed upstream of and closely to the joining mechanism, for preheating the elongate photosensitive web to a predetermined temperature.

According to the present invention, there is also provided a method of manufacturing a photosensitive laminated body, comprising the steps of reeling out elongate photosensitive web comprising a support, a photosensitive material layer disposed on the support, and a protective film disposed on the photosensitive material layer, the protective film having a peel-off section and a residual section; forming a processed region which is transversely severable in the protective film of the elongate photosensitive web which has been reeled out, at a boundary position between the peel-off section and the residual section; peeling the peel-off section off from the elongate photosensitive web, leaving the residual section; obtaining boundary position information by directly detecting the boundary position of the elongate photosensitive web or detecting a mark disposed on the elongate photosensitive web in association with the boundary position; feeding a substrate which has been heated to a predetermined temperature to a joining position; adjusting a relative position of the boundary position and the substrate in the joining position, based on the obtained boundary position information; and positioning the residual section between the substrates and joining the photosensitive material layer from which the peel-off section is peeled off, to the substrate in the joining position, for producing a joined substrate.

According to the present invention, since the boundary position of the elongate photosensitive web or a mark disposed on the elongate photosensitive web in association with the boundary position is directly detected, the boundary position can highly accurately be positioned with respect to the joining position. As the relative position of the boundary position and the substrate in the joining position is adjusted based on the obtained boundary position information, the photosensitive material layer of the elongate photosensitive web can be joined accurately to a desired area of the substrate through a simple process and arrangement. Thus, a high-quality photosensitive laminated body can efficiently be produced.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF DRAWINGS

FIG. 1 is a schematic side elevational view of a manufacturing apparatus according to a first embodiment of the present invention;

FIG. 2 is an enlarged fragmentary cross-sectional view of an elongate photosensitive web used in the manufacturing apparatus;

FIG. 3 is a fragmentary plan view of the elongate photosensitive web with adhesive labels applied thereto;

FIG. 4 is a front elevational view of a joining mechanism of the manufacturing apparatus;

FIG. 5 is a fragmentary cross-sectional view of a through region of the manufacturing apparatus;

FIG. 6 is a schematic view of a portion of the manufacturing apparatus, showing an initial state thereof;

FIG. 7 is a fragmentary side elevational view showing the manner in which a protective film is peeled off from the elongate photosensitive web;

FIG. 8 is a schematic view of a portion of the manufacturing apparatus, showing the manner in which a glass substrate enters between rubber rollers;

FIG. 9 is a schematic view of a portion of the manufacturing apparatus, showing the manner in which the rubber rollers start to rotate;

FIG. 10 is a schematic view of a portion of the manufacturing apparatus, showing its operation upon completion of a lamination process on a first glass substrate;

FIG. 11 is a schematic view of a portion of the manufacturing apparatus, showing the manner in which the rubber rollers and substrate feed rollers rotate;

FIG. 12 is a fragmentary cross-sectional view of glass substrates to which a photosensitive resin layer is transferred;

FIG. 13 is a schematic view of a portion of the manufacturing apparatus, showing the manner in which the substrate feed rollers are spaced from an end of a joined substrate;

FIG. 14 is a schematic view of a portion of the manufacturing apparatus, showing the manner in which elongate photosensitive webs are severed between joined substrates;

FIG. 15 is a schematic view of a portion of the manufacturing apparatus, showing a stopped state thereof;

FIG. 16 is a schematic view of a portion of the manufacturing apparatus, showing a finished state thereof;

FIG. 17 is a schematic view of a portion of the manufacturing apparatus, showing the manner in which the elongate photosensitive web has its leading end set in position;

FIG. 18 is a plan view showing the manner in which a photosensitive resin layer is advanced with respect to a glass substrate;

FIG. 19 is a plan view showing the manner in which a photosensitive resin layer is delayed with respect to a glass substrate;

FIG. 20 is a schematic side elevational view of a manufacturing apparatus according to a second embodiment of the present invention;

FIG. 21 is a plan view showing the manner in which a photosensitive resin layer having a prescribed length is applied to a glass substrate;

FIG. 22 is a plan view showing the manner in which a photosensitive resin layer longer than a prescribed length is applied to a glass substrate;

FIG. 23 is a plan view showing the manner in which a photosensitive resin layer shorter than a prescribed length is applied to a glass substrate;

FIG. 24 is a schematic side elevational view of a manufacturing apparatus according to a third embodiment of the present invention;

FIG. 25 is an enlarged cross-sectional view of a pre-peeler of the manufacturing apparatus according to the third embodiment;

FIG. 26 is an enlarged cross-sectional view showing the manner in which the pre-peeler operates;

FIG. 27 is a view illustrative of the manner in which the position of a photosensitive resin layer applied to a glass substrate is detected; and

FIG. 28 is a schematic side elevational view of a conventional film applying apparatus.

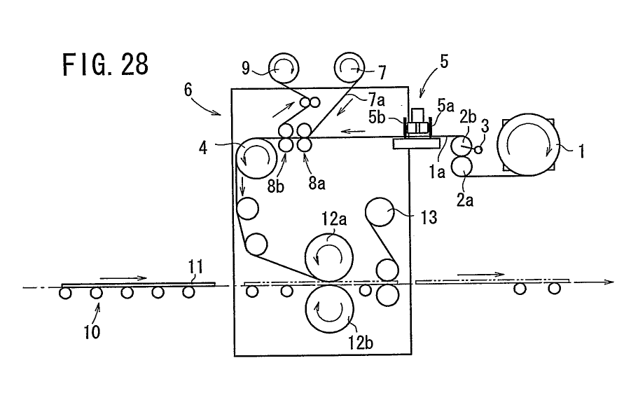

### BEST MODE FOR CARRYING OUT THE INVENTION

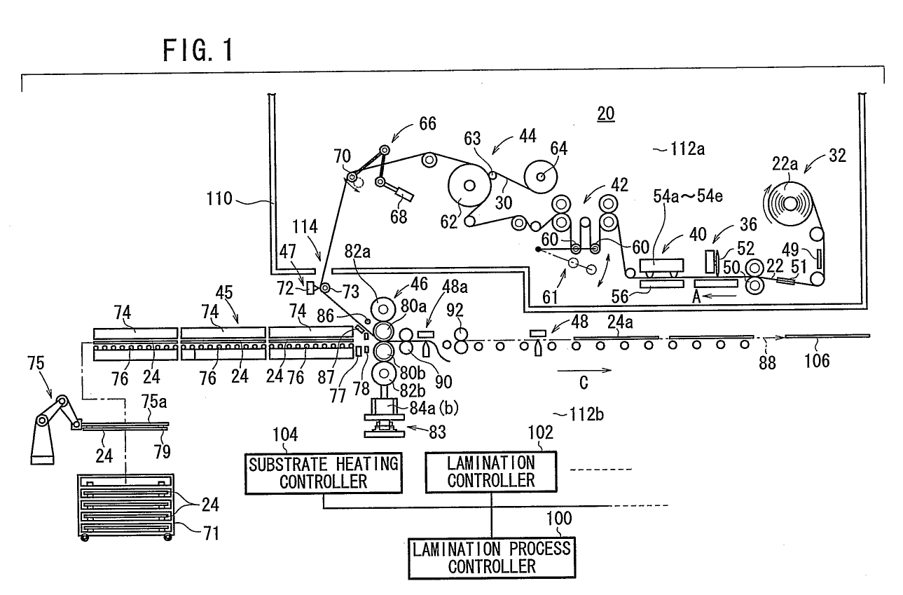

FIG. 1 shows in schematic side elevation an apparatus 20 for manufacturing a photosensitive laminated body according to a first embodiment of the present invention. The manufacturing apparatus 20 operates to thermally transfer a photosensitive resin layer 28 (described later) of an elongate photosensitive web 22 to glass substrates 24 in a process of manufacturing liquid crystal or organic EL color filters.

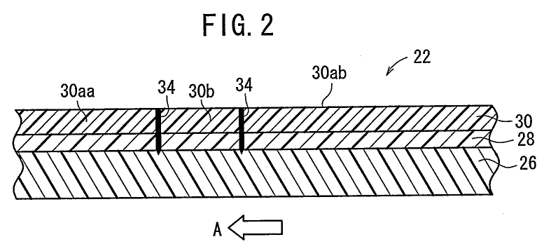

FIG. 2 shows in cross section the photosensitive web 22 that is employed in the manufacturing apparatus 20. The photosensitive web 22 comprises a laminated assembly of a flexible base film (support) 26, a photosensitive resin layer (photosensitive material layer) 28 disposed on the flexible base film 26, and a protective film 30 disposed on the photosensitive-resin layer 28.

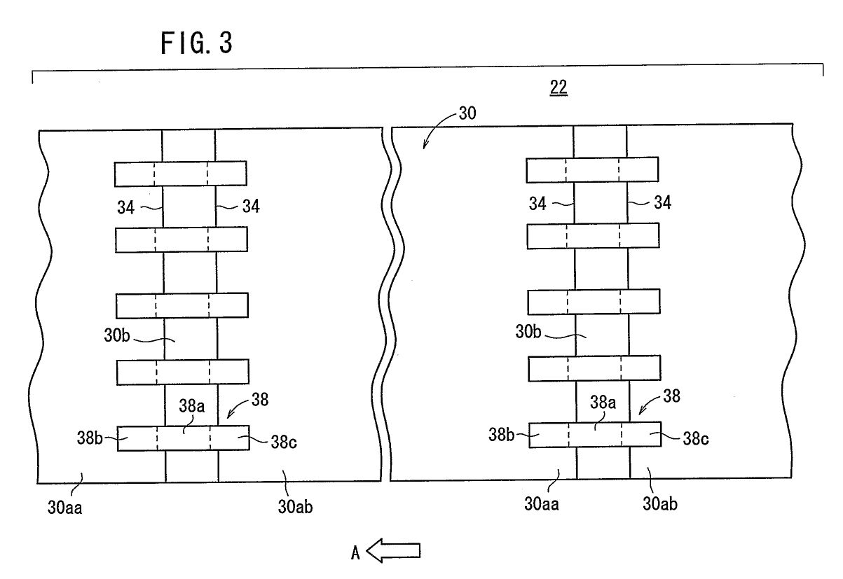

As shown in FIG. 1, the manufacturing apparatus 20 has a reel-out mechanism for accommodating a photosensitive web roll 22a in the form of rolled photosensitive web 22 and reeling out the photosensitive web 22 from the photosensitive web roll 22a, a processing mechanism 36 for forming a partly cut region (a processed region) 34 which is located at a transversely severable boundary position in a protective film 30 of the photosensitive web 22 reeled out from the photosensitive web roll 22a, and a label bonding mechanism 40 for bonding adhesive labels 38 (see FIG. 3) each having a non-adhesion area 38a to the protective film 30.

The manufacturing apparatus 20 also has, positioned downstream of the label bonding mechanism 40, a reservoir mechanism 42 for changing the feed mode of the photosensitive web 22 from an intermittent feed mode to a continuous feed mode, a peeling mechanism 44 for peeling a predetermined length of the protective film 30 from the photosensitive web 22, a substrate feed mechanism 45 for feeding a glass substrate 24 which is heated to a predetermined temperature to a joining position, and a joining mechanism 46 for joining the photosensitive resin layer 28 which has been exposed by peeling off the protective film 30 to the glass substrate 24.

A detecting mechanism 47 for directly detecting the partly cut region 34 at the boundary position of the photosensitive web 22 is disposed upstream of and closely to the joining position in the joining mechanism 46. An inter-substrate web cutting mechanism 48 for cutting the photosensitive web 22 between adjacent glass substrates 24 is disposed downstream of the joining mechanism 46. A web cutting mechanism 48a that is used when the manufacturing apparatus 20 starts and finishes operating is disposed upstream of the inter-substrate web cutting mechanism 48.

A joining base 49 for joining the trailing end of photosensitive web 22 that has essentially been used up and the leading end of photosensitive web 22 that is to be newly used is disposed downstream or and closely to the reel-out mechanism 32. The joining base 49 is followed downstream by a film end position detector 51 for controlling transverse shifts of the photosensitive web 22 due to winding irregularities of the photosensitive web roll 22a. The film end of the photosensitive web 22 is positionally adjusted by transversely moving the reel-out mechanism 32. However, the film end of the photosensitive web 22 may be adjusted by a position adjusting mechanism combined with rollers. The reel-out mechanism 32 may comprise a multi-shaft mechanism including two or three unreeling shafts for supporting the photosensitive web roll 22a and feeding out the photosensitive web 22.

The processing mechanism 36 is disposed downstream of respective roller pairs 50 for calculating the diameter of the photosensitive web roll 22a accommodated in the reel-out mechanism 32. The processing mechanism 36 has a single circular blade 52 which travels transversely across the photosensitive web 22 to form a partly cut region 34 in the photosensitive web 22 at a given position thereon.

As shown in FIG. 2, the partly cut region 34 needs to be formed in and across at least the protective film 30. Actually, the circular blade 52 is set to a cutting depth large enough to cut into the photosensitive resin layer 28 or-the base film 26 in order to reliably cut off the protective film 30. The circular blade 52 may be fixed against rotation and moved transversely across the photosensitive web 22 to form the partly cut region 34, or may be rotated without slippage on the photosensitive web 22 and moved transversely across the photosensitive web 22 to form the partly cut region 34. The circular blade 52 may be replaced with a laser beam or ultrasonic cutter, a knife blade, or a pushing blade (Thompson blade), for example.

The processing mechanism 36 may comprise two processing mechanisms disposed at a predetermined interval in the direction indicated by the arrow A in which the photosensitive web 22 is fed, for simultaneously forming two partly cut regions 34 with a residual section 30b interposed therebetween.

Two closely spaced partly cut regions 34 formed in the protective film 30 serve to set a spaced interval between two adjacent glass substrates 24. For example, these partly cut regions 34 are formed in the protective film 30 at positions that are 10 mm spaced inwardly from respective edges of the glass substrates 24. The section of the protective film 30 which is interposed between the partly cut regions 34 and exposed between the glass substrates 24 functions as a mask when the photosensitive resin layer 28 is applied as a frame to the glass substrate 24 in the joining mechanism 46 to be described later.

The label bonding mechanism 40 supplies adhesive labels 38 for interconnecting a front peel-off section 30aa and a rear peel-off section 30ab in order to leave a residual section 30b of the protective film 30 between glass substrates 24. As shown in FIG. 2, the front peel-off section 30aa which is to be peeled off initially and the rear peel-off section 30ab which is to be peeled off subsequently are positioned on respective both sides of the residual section 30b.

As shown in FIG. 3, each of the adhesive labels 38 is of a rectangular strip shape and is made of the same material as the protective film 30. Each of the adhesive labels 38 has a non-adhesion (or slightly adhesive) area 38a positioned centrally which is free of an adhesive, and a first adhesion area 38b and a second adhesion area 38c which are disposed respectively on the longitudinally opposite ends of the reverse side (adhesion side) of the non-adhesion area 38a, i.e., on the longitudinally opposite end portions of the adhesive label 38, the first adhesion area 38b and the second adhesion area 38c being bonded respectively to the front peel-off section 30aa and the rear peel-off section 30ab.

As shown in FIG. 1, the label bonding mechanism 40 has suction pads 54a through 54e for applying a maximum of five adhesive labels 38 at predetermined intervals. A support base 56 that is vertically movable for holding the photosensitive web 22 from below is disposed in a position where adhesive labels 38 are applied to the photosensitive web 22 by the suction pads 54a through 54e.

The reservoir mechanism 42 absorbs a speed difference between the intermittent feed mode in which the photosensitive web 22 is fed upstream of the reservoir mechanism 42 and the continuous feed mode in which the photosensitive web 22 is fed downstream of the reservoir mechanism 42. The reservoir mechanism 42 has a dancer roller unit 61 comprising two dancer rollers 60 which are rotatable and swingable for blocking variations of the tension. The dancer roller unit 61 may comprise only one roller or three or more rollers, depending on a desirable amount of reservoir of a web.

The peeling mechanism 44, which is disposed downstream of the reservoir mechanism 42, has a suction drum 62 for blocking variations of the tension to which the supplied photosensitive web 22 is subjected for thereby stabilizing the tension of the photosensitive web 22 when it is subsequently laminated. The peeling mechanism 44 also has a peeling roller 63 disposed closely to the suction drum 62. The protective film 30 that is peeled off from the photosensitive web 22 at a sharp peel-off angle is wound, except residual sections 30b, by a protective film takeup unit 64.

A tension control mechanism 66 for imparting tension to the photosensitive web 22 is disposed downstream of the peeling mechanism 44. The tension control mechanism 66 has a cylinder 68 that is actuatable to angularly displace a tension dancer 70 to adjust the tension of the photosensitive web 22 with which the tension dancer 70 is held in rolling contact. The tension control mechanism 66 may be employed only when necessary, and may be dispensed with.

The detecting mechanism 47 has a photoelectric sensor 72 such as a laser sensor, a photosensor, or the like for directly detecting changes in the photosensitive web 22 due to wedge-shaped grooves in the partly cut regions 34, steps produced by different thicknesses of the protective film 30, or a combination thereof. Detected signals from the photoelectric sensor 72 are used as boundary position signals representative of the boundary positions in the protective film 30. The photoelectric sensor 72 is disposed in confronting relation to a backup roller 73. Alternatively, a non-contact displacement gauge or image inspecting means such as a CCD camera or the like may be employed instead of the photoelectric sensor 72.

The positional data of the partly cut regions 34 which are detected by the detecting mechanism 47 can be statistically processed and converted into graphic data in real time. When the positional data detected by the detecting mechanism 47 show an undue variation or bias, the manufacturing apparatus 20 may generate a warning.

The manufacturing apparatus 20 may employ a different system for generating boundary position signals. According to such a different system, the partly cut regions 34 are not directly detected, but marks are applied to the photosensitive web 22. For example, holes or recesses may be formed in the photosensitive web 22 near the partly cut regions 34 in the vicinity of the processing mechanism 36, or the photosensitive web 22 may be slit by a laser beam or an aqua jet or may be marked by an ink jet or a printer. The marks on the photosensitive web 22 are detected, and detected signals are used as boundary position signals.

The substrate feed mechanism 45 has a plurality of substrate heating units (e.g., heaters) 74 disposed for sandwiching and heating glass substrates 24, and a feeder 76 for feeding glass substrates 24 in the direction indicated by the arrow C. The temperatures of the glass substrates 24 in the substrate heating units 74 are monitored at all times. When the monitored temperature of a glass substrate 24 becomes abnormal, the feeder 76 is inactivated and a warning is issued, and abnormality information is sent to reject and discharge the abnormal glass substrate 24 in a subsequent process, and is also used for quality control and production management. The feeder 76 has an air-floated plate (not shown) for floating and feeding glass substrates 24 in the direction indicated by the arrow C. Instead, the feeder 76 may comprise a roller conveyor for feeding glass substrates 24.

The temperatures of the glass substrates 24 should preferably be measured in the substrate heating units 74 or immediately prior to the joining position according to a contact process (using a thermocouple, for example) or a non-contact process.

A substrate storage frame 71 for storing a plurality of glass substrates 24 is disposed upstream of the substrate heating unit 74. The glass substrates 24 stored in the substrate storage frame 71 are attracted one by one by a suction pad 79 on a hand 75a of a robot 75, taken out from the substrate storage frame 71, and inserted into the substrate heating units 74.

Downstream of the substrate heating units 74, there are disposed a stopper 77 for abutting against the leading end of a glass substrate 24 and holding the glass substrate 24, and a position sensor 78 for detecting the position of the leading end of the glass substrate 24. The position sensor 78 detects the position of the leading end of the glass substrate 24 on its way toward the joining position. After the position sensor 78 has detected the position of the leading end of the glass substrate 24, the glass substrate 24 is fed a predetermined distance and is positioned between rubber rollers 80a, 80b of the joining mechanism 46. Preferably, a plurality of position sensors 78 are disposed at predetermined intervals along the feed path for monitoring the times at which a glass substrate 24 reaches the respective positions of the position sensors 78, thereby to check a delay due to a slippage or the like of the glass substrate 24 when the glass substrate 24 starts to be fed. In FIG. 1, glass substrates 24 are heated by the substrate heating units while the glass substrates 24 are being fed. However, glass substrates 24 may be heated in a batch-heating oven and fed by a robot.

The joining mechanism 46 has a pair of vertically spaced laminating rubber rollers 80a, 80b that can be heated to a predetermined temperature. The joining mechanism 46 also has a pair of backup rollers 82a, 82b held in rolling contact with the rubber rollers 80a, 80b, respectively. The backup roller 82b is pressed against the rubber roller 80b by a roller clamp unit 83.

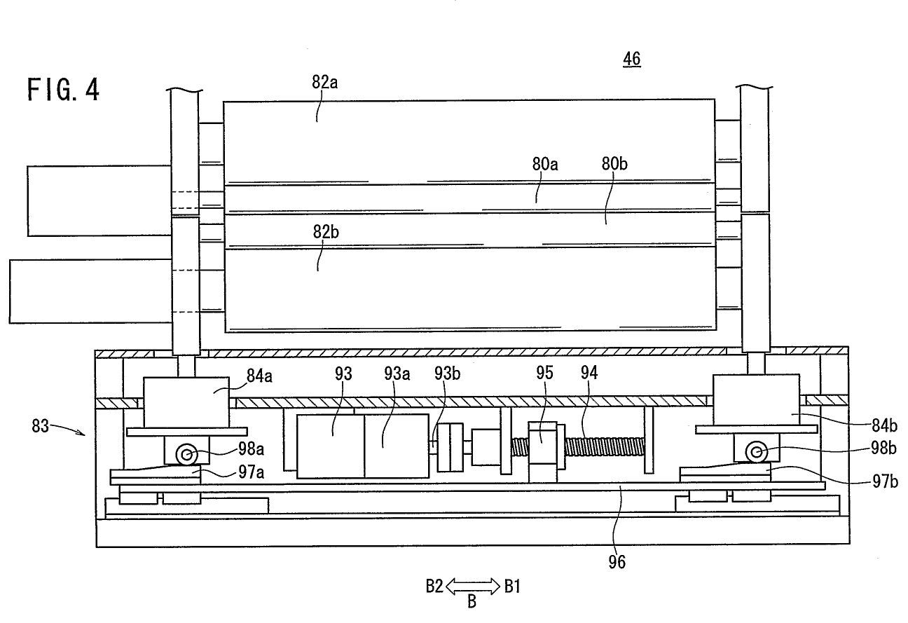

As shown in FIG. 4, the roller clamp unit 83 has a drive motor (actuator) 93 having a drive shaft coupled to a speed reducer 93a which has a drive shaft 93b coaxially connected to a ball screw 94. A nut 95 is threaded over the ball screw 94 and fixed to a slide base 96. Tapered cams 97a, 97b are fixedly mounted on respective opposite ends of the slide base 96 in the transverse direction of the photosensitive web 22, which is indicated by the arrow B. The tapered cams 97a, 97b are progressively higher in the direction indicated by the arrow B1. Rollers 98a, 98b are placed on the respective tapered cams 97a, 97b and held on the respective lower ends of pressing cylinders 84a, 84b.

As shown in FIG. 1, a contact prevention roller 86 is movably disposed near the rubber roller 80a for preventing the photosensitive web 22 from contacting the rubber roller 80a. A preheating unit 87 for preheating the photosensitive web 22 to a predetermined temperature is disposed upstream of and closely to the joining mechanism 46. The preheating unit 87 comprises an infrared bar heater or a heat applying means.

Glass substrates 24 are fed from the joining mechanism 46 through the inter-substrate web cutting mechanism 48 along a feed path 88 which extends in the direction indicated by the arrow C. The feed path 88 comprises an array of rollers including film feed rollers 90 and substrate feed rollers 92 with the web cutting mechanism 48a interposed therebetween. The distance between the rubber rollers 80a, 80b and the substrate feed rollers 92 is equal to or less than the length of one glass substrate 24.

In the manufacturing apparatus 20, the reel-out mechanism 32, the processing mechanism 36, the label bonding mechanism 40, the reservoir mechanism 42, the peeling mechanism 44, the tension control mechanism 66, and the detecting mechanism 47 are disposed above the joining mechanism 46. Conversely, the reel-out mechanism 32, the processing mechanism 36, the label bonding mechanism 40, the reservoir mechanism 42, the peeling mechanism 44, the tension control mechanism 66, and the detecting mechanism 47 may be disposed below the joining mechanism 46, so that the photosensitive web 22 may be rendered upside down such that the photosensitive resin layer 28 is joined to the lower surfaces of glass substrates 24. Alternatively, all the mechanisms of the manufacturing apparatus 20 may be linearly arrayed.

As shown in FIG. 1, the manufacturing apparatus 20 is controlled in its entirety by a lamination process controller 100. The manufacturing apparatus 20 also has a lamination controller 102, a substrate heating controller 104, etc. for controlling the different functional components of the manufacturing apparatus 20. These controllers are interconnected by an in-process network. The lamination process controller 100 is connected to the network of a factory which incorporates the manufacturing apparatus 20, and performs information processing for production, e.g., production management and mechanism operation management, based on instruction information (condition settings and production information) from a factory CPU (not shown).

The substrate heating controller 104 controls the substrate heating units 74 to receive glass substrates 24 from an upstream process and heat the received glass substrates 24 to a desired temperature, controls the feeder 76 to feed the heated glass substrates 24 to the joining mechanism 46, and also controls the handling of information about the glass substrates 24.

The lamination controller 102 serves as process master for controlling the functional components of the manufacturing apparatus 20. The lamination controller 102 operates as a control mechanism for controlling, for example, the substrate feed mechanism 45 based on the positional information, detected by the detecting mechanism 47, of the partly cut regions 34 of the photosensitive web 22.

The installation space of the manufacturing apparatus 20 is divided into a first clean room 112a and a second clean room 112b by a partition wall 110. The first clean room 112a houses therein the reel-out mechanism 32, the processing mechanism 36, the label bonding mechanism 40, the reservoir mechanism 42, the peeling mechanism 44, and the tension control mechanism 66. The second clean room 112b houses therein the detecting mechanism 47 and the other components following the detecting mechanism 47. The first clean room 112a and the second clean room 112b are connected to each other by a through region 114.

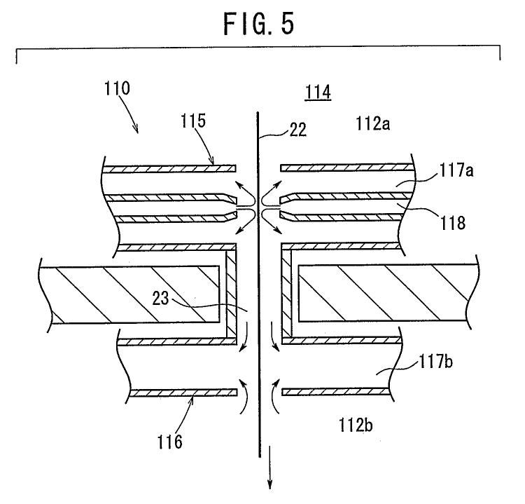

As shown in FIG. 5, the through region 114 has a deduster 115 disposed in the first clean room 112a and an air sealer 116 disposed in the second clean room 112b.

The deduster 115 has a pair of suction nozzles 117a disposed in confronting relation to opposite surfaces of the photosensitive web 22, and a pair of ejection nozzles 118 disposed respectively in the suction nozzles 117a. The ejection nozzles 118 eject air to the photosensitive web 22 to remove dust particles from the photosensitive web 22, and the suction nozzles 117a draw the ejected air and the removed dust particles. Preferably, the air from the ejection nozzles 118 may be electric neutralizing (or antistatic) air.

The air sealer 116 has a pair of suction nozzles 117b disposed in confronting relation to opposite surfaces of the photosensitive web 22. The suction nozzles 117b draw air to seal the through region 114. The deduster 115 and the air sealer 116 may be switched around in position, or a plurality of dedusters 115 and a plurality of air sealers 116 may be combined with each other. Only the suction nozzle 117a, but not the ejection nozzle 118, may be disposed in confronting relation to the side of the photosensitive web 22 where the photosensitive resin layer 28 is exposed.

In the manufacturing apparatus 20, the partition wall 110 prevents heated air from the joining mechanism 46 from thermally affecting the photosensitive web 22, i.e., from wrinkling, deforming, thermally shrinking, or stretching the photosensitive web 22. The partition wall 110 separates an upper area of the manufacturing apparatus 20, i.e., the first clean room 112a, where dust particles are liable to occur and fall, from a lower area of the manufacturing apparatus 20, i.e., the second clean room 112b, thereby keeping the joining mechanism 46 in particular clean. It is desirable to keep the pressure in the second clean room 112b higher than the pressure in the first clean room 112a, thereby preventing dust particles from flowing from the first clean room 112a into the second clean room 112b.

An air supply (not shown) for supplying a downward flow of clean air is disposed in an upper portion of the second clean room 112b.

Operation of the manufacturing apparatus 20 for carrying out a manufacturing method according to the present invention will be described below.

Initially for positioning the leading end of the photosensitive web 22 in place, the photosensitive web 22 is unreeled from the photosensitive web roll 22a accommodated in the reel-out mechanism 32. The photosensitive web 22 is delivered through the processing mechanism 36, the label bonding mechanism 40, the reservoir mechanism 42, the peeling mechanism 44, and the joining mechanism 46 to the film feed rollers 90. The leading end of the photosensitive web 22 is pinched by the film feed rollers 90.

When a partly cut region 34 is detected by the photoelectric sensor 72, the film feed roller 90 is rotated based on a detected signal from the photoelectric sensor 72. The photosensitive web 22 is now fed a predetermined distance to the joining position by the film feed roller 90. The partly cut region 34 is positioned correspondingly to the joining position. Alternatively, the partly cut region 34 may be detected at a downstream position of the joining position, and the photosensitive web 22 may be stopped at a predetermined position.

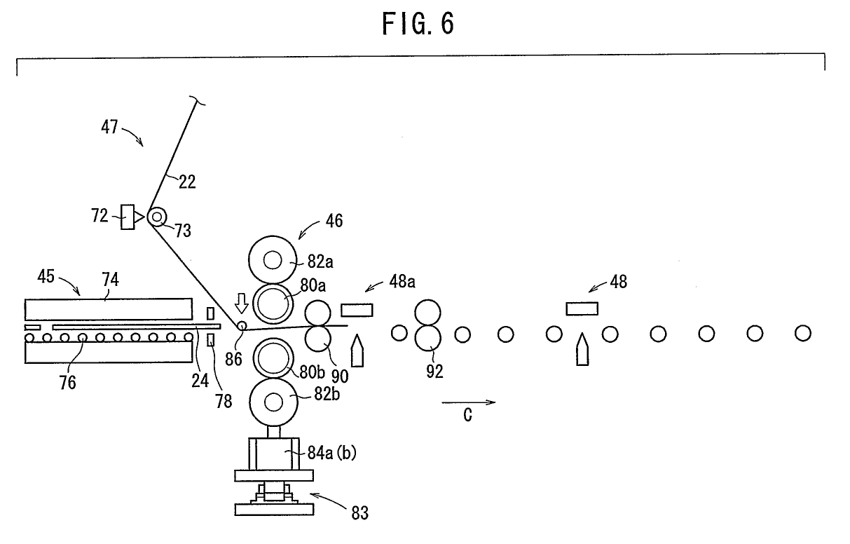

As shown in FIG. 6, the contact prevention roller 86 is lowered to prevent the photosensitive web 22 from contacting the rubber roller 80a. A glass substrate 24 is waiting immediately prior to the joining position. The photosensitive web 22 is now in an initial state of the manufacturing apparatus 20.

Operation of the functional components of the manufacturing apparatus 20 in a lamination mode will be described below.

As shown in FIG. 1, in the processing mechanism 36, the circular blade 52 moves transversely across the photosensitive web 22 to cut into the protective film 30, the photosensitive resin layer 28, and the base film 26, thereby forming a partly cut region 34 (see FIG. 2). Then, the photosensitive web 22 is fed again a distance corresponding to the dimension of the residual section 30b of the protective film 30 in the direction indicated by the arrow A (see FIG. 1), and then stopped, whereupon another partly cut region 34 is formed therein by the circular blade 52. As shown in FIG. 2, a front peel-off section 30aa and a rear peel-off section 30ab are now provided in the photosensitive web 22, with the residual section 30b interposed therebetween.

Then, the photosensitive web 22 is fed to the label bonding mechanism 40 to place a predetermined bonding area of the protective film 30 on the support base 56. In the label bonding mechanism 40, a predetermined number of adhesive labels 38 are attracted under suction and held by the suction pads 54b through 54e and are securely bonded to the front peel-off section 30aa and the rear peel-off section 30ab of the protective film 30 across the residual section 30b thereof (see FIG. 3).

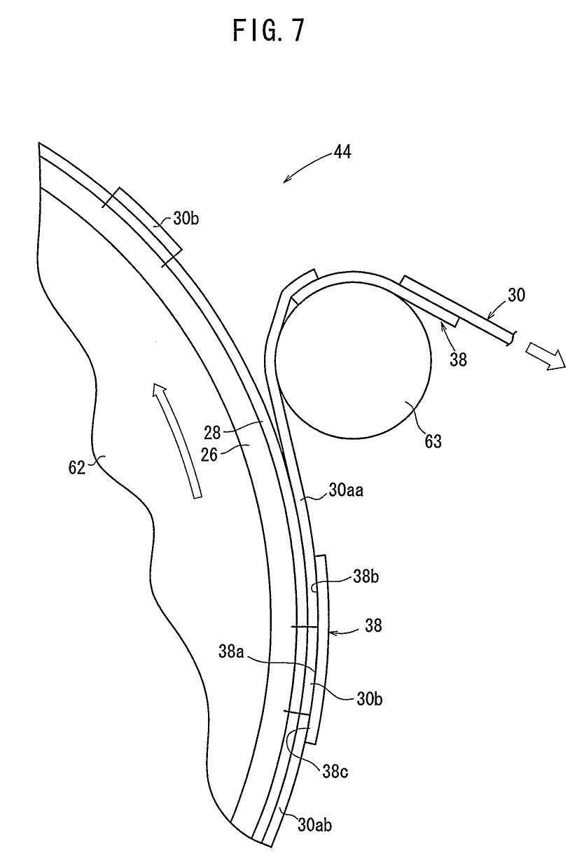

The photosensitive web 22 with the five adhesive labels 38 bonded thereto, for example, is isolated by the reservoir mechanism 42 from variations of the tension to which the supplied photosensitive web 22 are subjected, and then continuously fed to the peeling mechanism 44. In the peeling mechanism 44, as shown in FIG. 7, the base film 26 of the photosensitive web 22 is attracted to the suction drum 62, and the protective film 30 is peeled off from the photosensitive web 22, leaving the residual sections 30b. The protective film 30 is peeled off at a sharp peel-off angle and wound by the protective film takeup unit 64 (see FIG. 1). Preferably, electric neutralizing air may be blown on the peeled portions.

At this time, inasmuch as the photosensitive web 22 is firmly held by the suction drum 62, shocks produced when the protective film 30 is peeled off from the photosensitive web 22 are not transferred to the photosensitive web 22 downstream of the suction drum 62. Consequently, such shocks are not transferred to the joining mechanism 46, and hence laminated sections of glass substrates 24 are effectively prevented from developing a striped defective region.

After the protective film 30 has been peeled off from the base film 26, leaving the residual sections 30b, by the peeling mechanism 44, the photosensitive web 22 is adjusted in tension by the tension control mechanism 66, and then the partly cut region 34 of the photosensitive web 22 is detected by the photoelectric sensor 72 of the detecting mechanism 47.

Based on detected information of the partly cut region 34, the film feed rollers 90 are rotated to feed the photosensitive web 22 a predetermined length to the joining mechanism 46. At this time, the contact prevention roller 86 is waiting above the photosensitive web 22 and the rubber roller 80b is disposed below the photosensitive web 22.

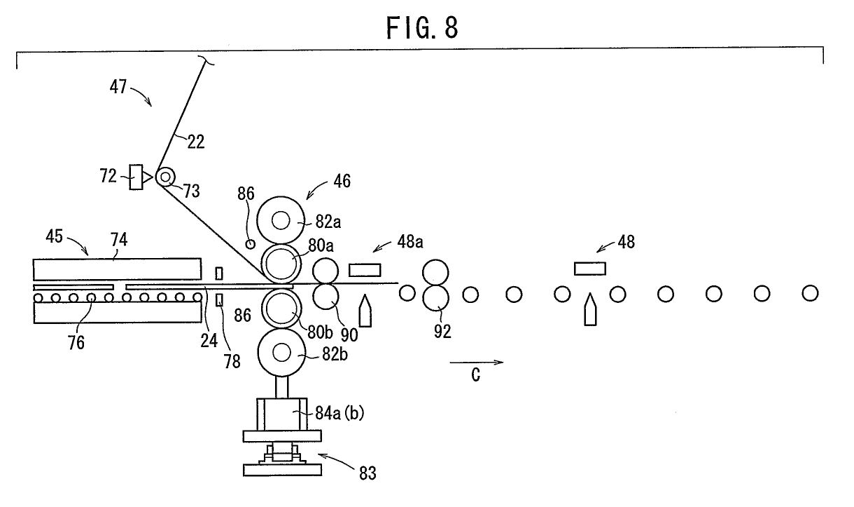

As shown in FIG. 8, the first glass substrate 24 which is preheated is fed to the joining position by the substrate feed mechanism 45. The glass substrate 24 is tentatively positioned between the rubber rollers 80a, 80b in alignment with the joined photosensitive resin layer 28 of the photosensitive web 22.

Then, as shown in FIG. 4, the ball screw 94 is rotated in a certain direction by the speed reducer 93a coupled to the drive motor 93, moving the slide base 96 in the direction indicated by the arrow B2 in unison with the nut 95 threaded over the ball screw 94. Therefore, the tapered cams 97a, 97b have their cam surfaces in contact with the rollers 98a, 98b raised, displacing the rollers 98a, 98b upwardly. The pressing cylinders 84a, 84b are elevated, lifting the backup roller 82b and the rubber roller 80b to sandwich the glass substrate 24 under a predetermined pressing pressure between the rubber rollers 80a, 80b. At this time, the pressing pressure is adjusted by the pressure of air supplied to the pressing cylinders 84a, 84b. The rubber roller 80a is rotated to transfer, i.e., laminate, the photosensitive resin layer 28, which is melted with heat, to the glass substrate 24.

The photosensitive resin layer 28 is laminated onto the glass substrate 24 under such conditions that the photosensitive resin layer 28 is fed at a speed in the range from 1.0 m/min. to 10.0 m/min., the rubber rollers 80a, 80b have a temperature ranging from 100° C. to 150° C., and a hardness ranging from 40 to 90, and apply a pressure (linear pressure) ranging from 50 N/cm to 400 N/cm.

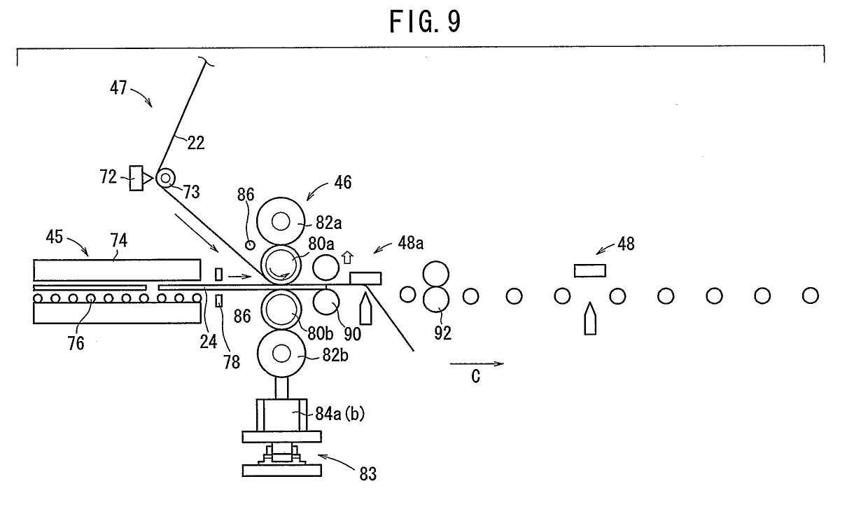

As shown in FIG. 9, when the leading end of the glass substrate 24 reaches a position near the film feed rollers 90, the film feed rollers 90 are moved away from the glass substrate 24. When the leading end of the photosensitive web 22 which projects forwardly of the glass substrate 24 in the direction indicated by the arrow C reaches a predetermined position with respect to the web cutting mechanism 48a, the web cutting mechanism. 48a is actuated to cut off the leading end of the photosensitive web 22. The web cutting mechanism 48a returns to its standby position except for the time of cutting off the leading end of the photosensitive web 22, the time of operation termination, and the time of cutting off the photosensitive web 22 in case of trouble. The web cutting mechanism 48a will not be used while the manufacturing apparatus 20 is in normal operation.

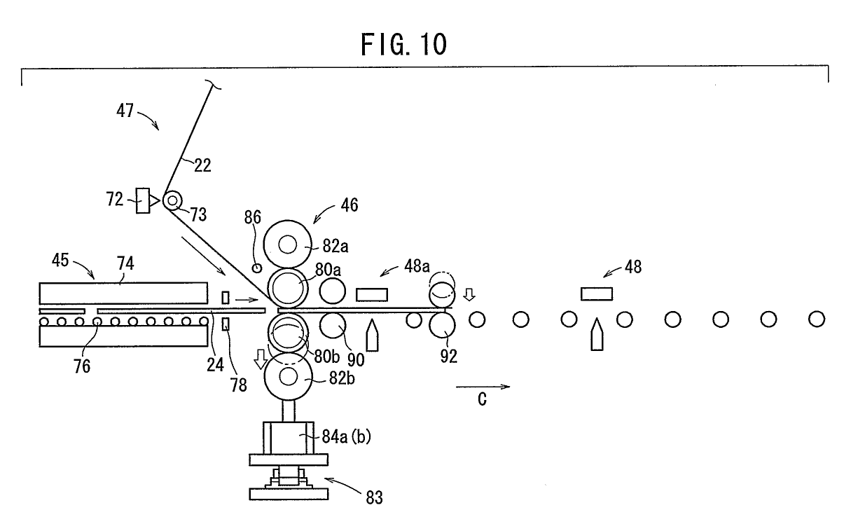

As shown in FIG. 10, when the photosensitive web 22 has been laminated onto the glass substrate 24 up to its trailing end by the rubber rollers 80a, 80b, the rubber roller 80a is stopped against rotation, and the glass substrate 24 with the laminated photosensitive web 22 (also referred to as “joined substrate 24a”) is clamped by the substrate feed rollers 92.

The rubber roller 80b is retracted away from the rubber roller 80a, unclamping the joined substrate 24a. Specifically, as shown in FIG. 4, the speed reducer 93a coupled to the drive motor 93 is reversed, causing the ball screw 94 and the nut 95 to move the slide base 96 in the direction indicated by the arrow B1. Therefore, the tapered cams 97a, 97b have their cam surfaces in contact with the rollers 98a, 98b lowered, displacing the pressing cylinders 84a, 84b downwardly. The backup roller 82b and the rubber roller 80b are lowered, unclamping the joined substrate 24a.

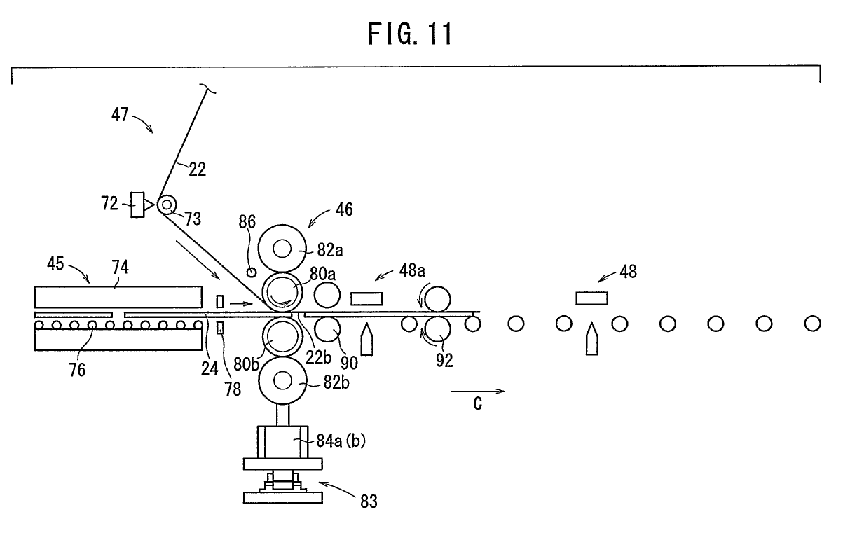

The substrate feed rollers 92 then start rotating to feed the joined substrate 24a a predetermined distance in the direction indicated by the arrow C. The position 22b of the photosensitive web 22 which is to be brought between two adjacent glass substrates 24 is now displaced to a position beneath the rubber roller 80a. A next glass substrate 24 is fed toward the joining position by the substrate feed mechanism 45. When the leading end of the next glass substrate 24 is positioned between the rubber rollers 80a, 80b, the rubber roller 80b is lifted, clamping the next glass substrate 24 and the photosensitive web 22 between the rubber rollers 80a, 80b. At the same time, the substrate feed rollers 92 clamp the joined substrate 24a. The rubber rollers 80a, 80b and the substrate feed roller 92 are rotated to start laminating the photosensitive web 22 onto the glass substrate 24 and feed a joined substrate 24a in the direction indicated by the arrow C (see FIG. 11).

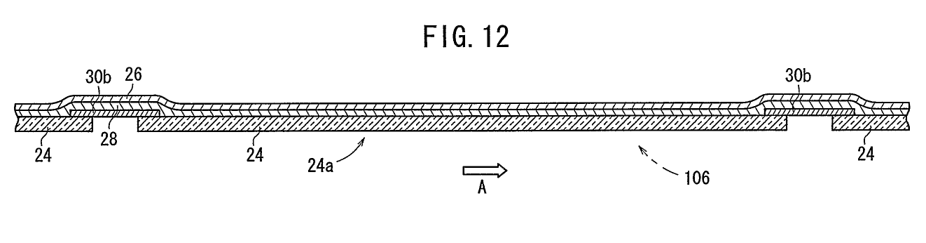

At this time, as shown in FIG. 12, the joined substrate 24a has opposite ends covered with respective residual sections 30b.

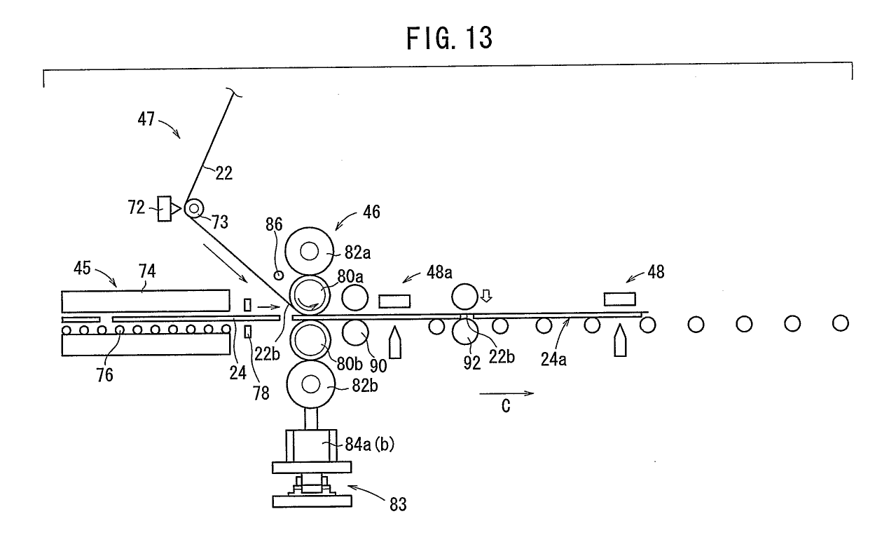

As shown in FIG. 13, when the trailing end of the first joined substrate 24a reaches the substrate feed rollers 92, the upper one of the substrate feed rollers 92 is lifted to unclamp the first joined substrate 24a, and the lower one of the substrate feed rollers 92 and the other rollers of the feed path 88 are continuously rotated to feed the joined substrate 24a. When the trailing end of the next, i.e., second, joined substrate 24a reaches a position near the rubber rollers 80a, 80b, the rubber rollers 80a, 80b and the substrate feed rollers 92 are stopped against rotation. The upper one of the substrate feed rollers 92 is lowered to clamp the second joined substrate 24a, and the rubber roller 80b is lowered to unclamp the second joined substrate 24a. Then, the substrate feed rollers 92 are rotated to feed the second joined substrate 24a. The position 22b of the photosensitive web 22 which is to be brought between two adjacent glass substrates 24 is now displaced to the position beneath the rubber roller 80a, and the photosensitive web 22 are repeatedly laminated onto a third glass substrate 24.

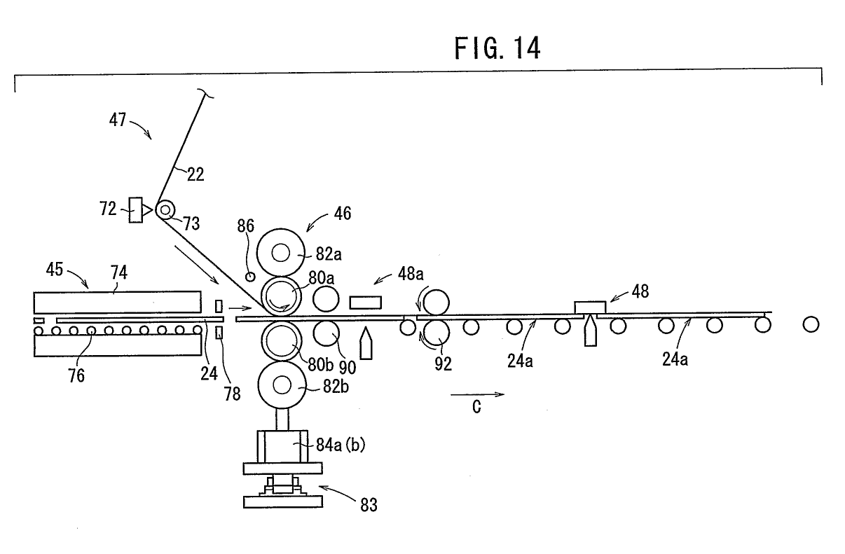

As shown in FIG. 14, when the position between two adjacent joined substrates 24a reaches a position corresponding to the inter-substrate web cutting mechanism 48, the inter-substrate web cutting mechanism 48 severs the photosensitive web 22 between the joined substrates 24a while moving in the direction indicated by the arrow C at the same speed as the joined substrates 24a. Thereafter, the inter-substrate web cutting mechanism 48 returns to a standby position, and the base films 26 and the residual sections 30b are peeled off from the leading joined substrate 24a, thereby manufacturing a photosensitive laminated body 106.

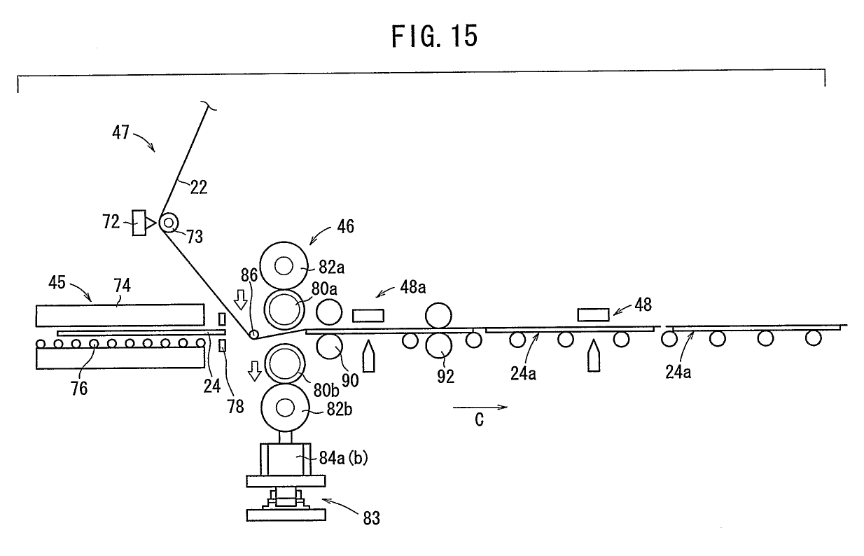

When the laminating process is temporarily stopped, as shown in FIG. 15, the film feed rollers 90 and the rubber roller 80b are brought into unclamping positions, and the contact prevention roller 86 is lowered to prevent the photosensitive web 22 from contacting the rubber roller 80a.

When the manufacturing apparatus 20 is to be shut off, the substrate feed rollers 92 are rotated to feed the joined substrate 24a in the direction indicated by the arrow C, and the film feed rollers 90 clamp the photosensitive web 22. While the film feed rollers 90 in rotation are clamping the photosensitive web 22, the web cutting mechanism 48a travels transversely across the photosensitive web 22, cutting off the photosensitive web 22.

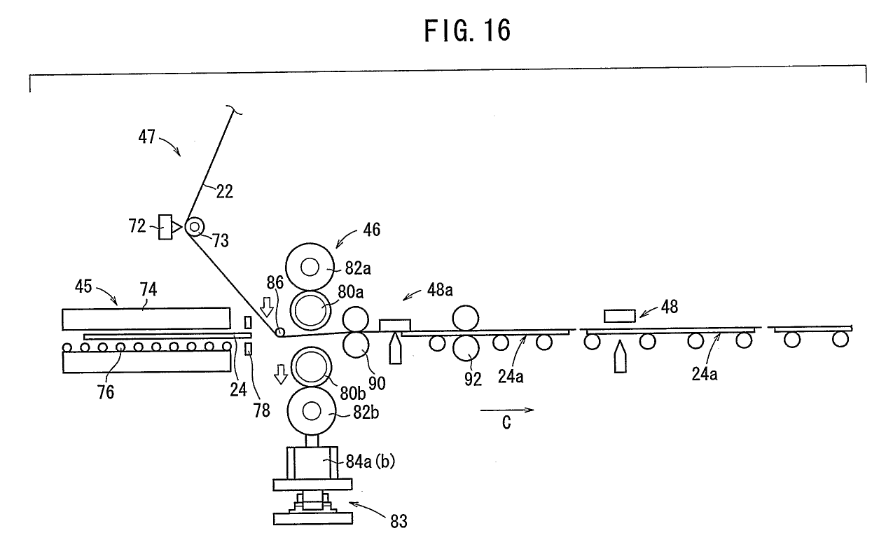

Consequently, as shown in FIG. 16, the photosensitive web 22 passes between the rubber rollers 80a, 80b and is sandwiched by the film feed rollers 90, and is supported away from the rubber roller 80a by the contact prevention roller 86 which is lowered. The web cutting mechanism 48a has been placed in its standby position.

When the inter-substrate web cutting mechanism 48 and the web cutting mechanism 48a cut off the photosensitive web 22, they move in synchronism with the photosensitive web 22 in the direction indicated by the arrow C. However, the inter-substrate web cutting mechanism 48 and the web cutting mechanism 48a may move only transversely across the photosensitive web 22 to cut off the photosensitive web 22. The photosensitive web 22 may be cut off by a Thompson blade while the web is held at rest, or may be cut off by a rotary blade while the web is in motion.

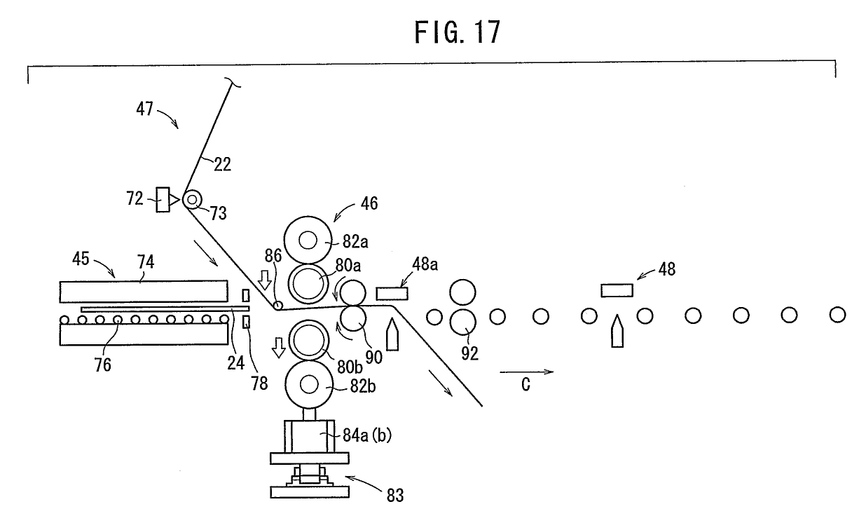

When the manufacturing apparatus 20 operates in its initial state, as shown in FIG. 17, the contact prevention roller 86 is disposed in the lower position and the rubber roller 80b is spaced away from the rubber roller 80a. Then, the film feed roller 90 is rotated to discharge the photosensitive web 22 into a web disposal container (not shown). At this time, the photosensitive web 22 is severed into a certain length by the web cutting mechanism 48a.

When the detecting mechanism 47 detects the partly cut region 34 of the photosensitive web 22, the photosensitive web 22 is fed a predetermined length from the detected position. Specifically, when the contact prevention roller 86 is elevated, the photosensitive web 22 is fed until the partly cut region 34 reach a position where the photosensitive web 22 are to be laminated by the rubber rollers 80a, 80b. The leading end of the photosensitive web 22 is now positioned in place.

In the first embodiment, the partly cut region 34 of the photosensitive web 22 is directly detected by the detecting mechanism 47 upwardly of and closely to the joining mechanism 46. The distance from the detecting mechanism 47 to the position where the partly cut region 34 is stopped by the rubber rollers 80a, 80b needs to be smaller than the shortest length of the photosensitive web 22 to be laminated. This is because the information of the detected partly cut region 34 is used for a next laminating process through feedback.

The detecting mechanism 47 performs two measuring processes as described below. According to the first measuring process, the rubber rollers 80a, 80b clamp the glass substrate 24, and the number of pulses generated by an encoder combined with a drive motor (not shown) for rotating the rubber rollers 80a, 80b, as representing the distance by which the glass substrate 24 is fed from the start of rotation of the rubber rollers 80a, 80b, is compared with the preset numbers of pulses generated when the partly cut region 34 is to be detected by the detecting mechanism 47, thereby measuring displacements of the partly cut region 34. If the partly cut region 34 of the photosensitive web 22 is detected before the preset number of pulses is reached, then the partly cut region 34 is judged as being displaced forwardly of a predetermined position on the glass substrate 24 by a distance indicated by the difference between the numbers of pulses. Conversely, if the partly cut region 34 of the photosensitive web 22 is detected after the preset number of pulses is reached, then the partly cut region 34 is judged as being displaced rearwardly of a predetermined position on the glass substrate 24.

According to the second measuring process, the number of pulses generated by an encoder combined with a drive motor (not shown) for rotating the rubber rollers 80a, 80b is measured from the detection of a partly cut region 34 to the detection of a next partly cut region 34, thereby measuring the laminated length H of the photosensitive web 22. The preset number of pulses corresponding to the laminated length under normal conditions of each of the photosensitive web 22 is compared with the actually measured number of pulses. If the actually measured number of pulses is greater than the preset number of pulses, then the photosensitive web 22 is judged as being stretched due to heat or the like by a distance indicated by the difference between the numbers of pulses. If the actually measured number of pulses is smaller than the preset number of pulses, then the photosensitive web 22 is judged as being short.

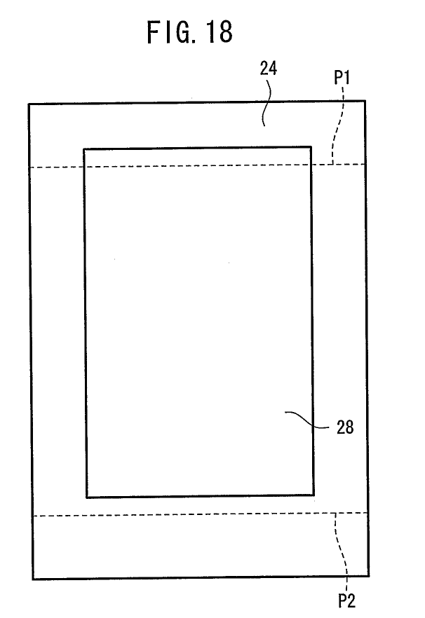

If the leading end of the photosensitive resin layer 28 is detected as being displaced (advanced) equal distances or substantially equal distances with respect to a joined range P1-P2 of the glass substrate 24 according to the first measuring process, as shown in FIG. 18, then the relative position of the glass substrate 24 and the partly cut regions 34 of the photosensitive web 22 is adjusted.

Specifically, if the partly cut region 34 detected by the photoelectric sensor 72 is detected as being advanced from a predetermined position, then as shown in FIG. 10, the substrate feed rollers 92 feed unjoined portions of the photosensitive web 22 after being laminated by a distance represented by the difference between the preset distance and the advanced distance. As a result, the partly cut region 34 is positionally adjusted and placed in a predetermined position between the rubber rollers 80a, 80b. Thereafter, the glass substrate 24 is delivered under normal delivery control between the rubber rollers 80a, 80b, and the photosensitive resin layer 28 is joined at a normal position to the glass substrate 24, i.e., in the joined range P1-P2 of the glass substrate 24.

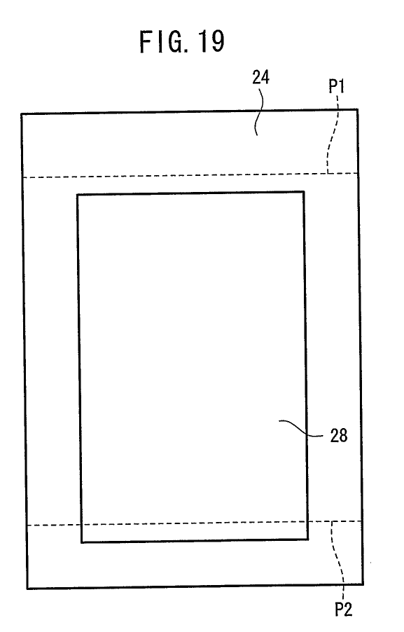

As shown in FIG. 19, if the partly cut region 34 detected by the photoelectric sensor 72 is detected as being delayed from the joined range P1-P2 of the glass substrate 24, then the substrate feed rollers 92 feed unjoined portions of the photosensitive web 22 after being laminated by a distance represented by the sum of the preset distance and the delayed distance.

Rather than adjusting the distance that the joined substrate 24a is fed by the substrate feed rollers 92, the substrate feed mechanism 45 may be controlled to adjust the position at which the glass substrate 24 is to be stopped, by the advanced or delayed distance.

The distance between the partly cut regions 34 detected by the photoelectric sensor 72, i.e., the length H of the photosensitive resin layer 28 to be joined to the glass substrate 24, is measured according to the second measuring process. If the length H is greater than the joined range, then the positions of the partly cut regions 34 are changed by the processing mechanism 36 so that the distance between the partly cut regions 34, i.e., the length H, is reduced by the difference. If the length H is smaller than the joined range, then the positions of the partly cut regions 34 are changed by the processing mechanism 36 so that the distance between the partly cut regions 34, i.e., the length H, is increased by the difference. In this manner, the joined length of the photosensitive resin layer 28 is adjusted to a predetermined length.

It is also possible to change the amount of stretch of the photosensitive web 22 by adjusting the tension of the photosensitive web 22 with the tension dancer 70 of the tension control mechanism 66.

Consequently, the partly cut regions 34 of the photosensitive web 22 can be positioned highly accurately with respect to the joining position, allowing the photosensitive resin layer 28 of the photosensitive web 22 to be joined accurately in a desired area of the glass substrate 24. It is thus possible to efficiently manufacture a high-quality photosensitive laminated body 106 through a simple process and arrangement.

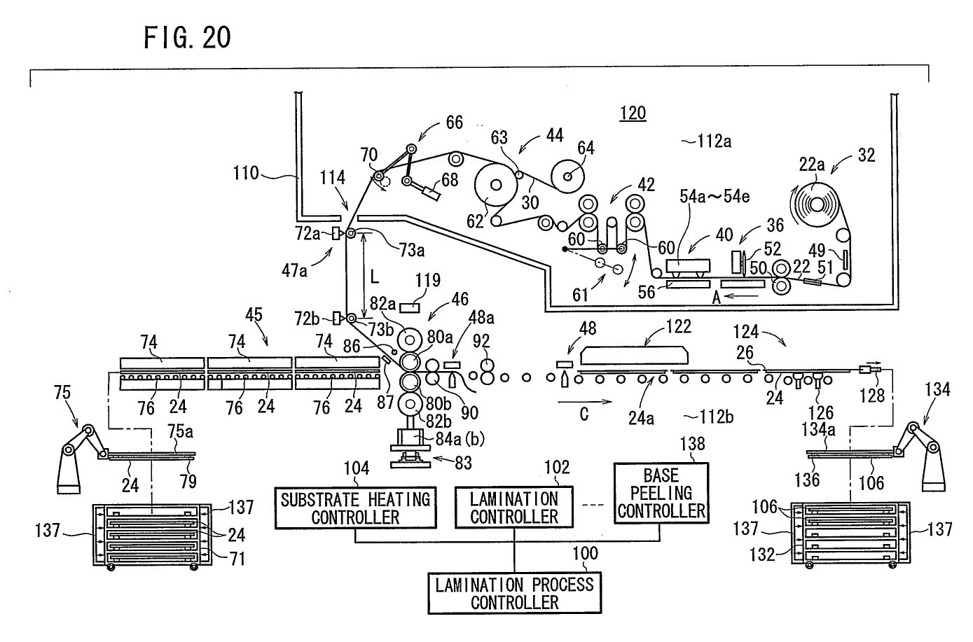

FIG. 20 schematically shows in side elevation a manufacturing apparatus 120 according to a second embodiment of the present invention. Those parts of the manufacturing apparatus 120 according to the second embodiment which are identical to those of the manufacturing apparatus 20 according to the first embodiment are denoted by identical reference characters, and will not be described in detail below.

As shown in FIG. 20, the manufacturing apparatus 120 has a detecting mechanism 47a, a cooling mechanism 122 disposed downstream of the inter-substrate web cutting mechanism 48, and a base peeling mechanism 124 disposed downstream of the cooling mechanism 122. The detecting mechanism 47a has photoelectric sensors 72a, 72b, which are spaced from each other by a predetermined distance L and disposed in confronting relation to backup rollers 73a, 73b, respectively.

The cooling mechanism 122 supplies cold air to a joined substrate 24a to cool the joined substrate 24a after the photosensitive web 22 is cut off between the joined substrate 24a and a following joined substrate 24a by the inter-substrate web cutting mechanism 48. Specifically, the cooling mechanism 122 supplies cold air having a temperature of 10° C. at a rate ranging from 1.0 to 2.0 m/min. Alternatively, the cooling mechanism 122 may be dispensed with, and the joined substrate 24a may be cooled in a photosensitive laminated body storage frame 132 (described later) without using any dedicated equipment for cooling.

The base peeling mechanism 124 disposed downstream of the cooling mechanism 122 has a plurality of suction pads 126 for attracting the lower surface of a joined substrate 24a. While the joined substrate 24a is being attracted under suction by the suction pads 126, the base films 26 and the residual sections 30b are peeled off from the joined substrate 24a by a robot hand 128. Electric neutralizing blowers (not shown) for ejecting ion air to four sides of the laminated area of the joined substrate 24a are disposed upstream, downstream, and laterally of the suction pads 126. The base films 26 and the residual sections 30b may be peeled off from the joined substrate 24a while a table for supporting the joined substrate 24a thereon is being oriented vertically, obliquely, or turned upside down for dust removal.

The base peeling mechanism 124 is followed downstream by the photosensitive laminated body storage frame 132 for storing a plurality of photosensitive laminated bodies 106. A photosensitive laminated body 106 that is produced when the base films 26 and the residual sections 30b are peeled off from the joined substrate 24a by the base peeling mechanism 124 is attracted by suction pads 136 on a hand 134a of a robot 134, taken out from the base peeling mechanism 124, and placed into the photosensitive laminated body storage frame 132.

Each of the substrate storage frame 71 and the photosensitive laminated body storage frame 132 has dedusting fan units (or duct units) 137 on three sides thereof except for a side from which the glass substrates 24 or the photosensitive laminated bodies 106 are placed into and taken out. The fan units 137 blow clean and electric neutralizing air into the substrate storage frame 71 and the photosensitive laminated body storage frame 132.

To the lamination process controller 100, there are connected the lamination controller 102, the substrate heating controller 104, and also a base peeling controller 138. The base peeling controller 138 controls the base peeling mechanism 124 to peel off the base film 26 from the joined substrate 24a that is supplied from the joining mechanism 46, and also to discharge the photosensitive laminated body 106 to a downstream process. The base peeling controller 138 also handles information about the joined substrate 24a and the photosensitive laminated body 106.

In the detecting mechanism 47a according to the second embodiment, the photoelectric sensor 72a which is positioned upstream of the photoelectric sensor 72b first detects the partly cut region 34 of the photosensitive web 22. Thereafter, the downstream photoelectric sensor 72b detects the partly cut region 34 of the photosensitive web 22. The distance L between the backup rollers 73a, 73b corresponds to the length of the photosensitive resin layer 28 applied to the glass substrate 24.

The actual applied length of the photosensitive resin layer 28 can accurately be calculated from the difference between the time when the upstream photoelectric sensor 72a detects the partly cut regions 34 of the photosensitive web 22 and the time when the downstream photoelectric sensor 72b detects the same partly cut region 34 of the photosensitive web 22. Based on the calculated actual applied length of the photosensitive resin layer 28, the speed at which the photosensitive web 22 is fed is adjusted to apply the photosensitive resin layer 28 centrally to the glass substrate 24.

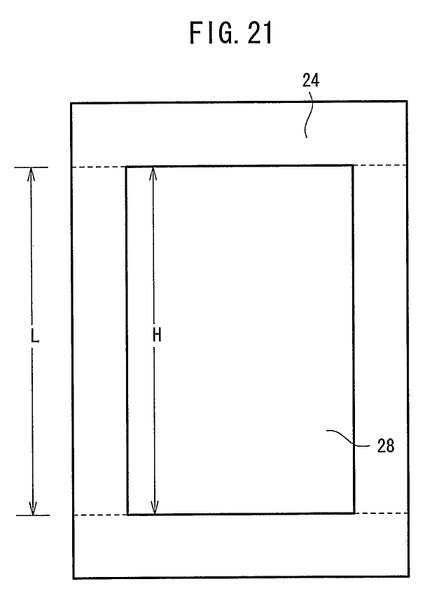

According to the second embodiment, therefore, the distance between the partly cut regions 34 of the photosensitive web 22, i.e., the length H of the photosensitive resin layer 28 applied to the glass substrate 24, is accurately detected to apply the photosensitive resin layer 28 centrally to the glass substrate 24 (see FIG. 21).

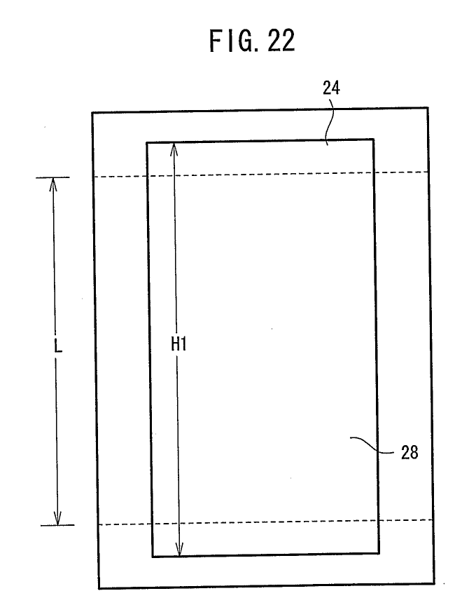

If the length H1 of the photosensitive resin layer 28 which is detected by the detecting mechanism 47a is larger than the normal length H, as shown in FIG. 22, then the photosensitive resin layer 28 is applied centrally to the glass substrate 24 such that the opposite ends of the photosensitive resin layer 28 are spaced equal distances outwardly from the ends of the applied length L.

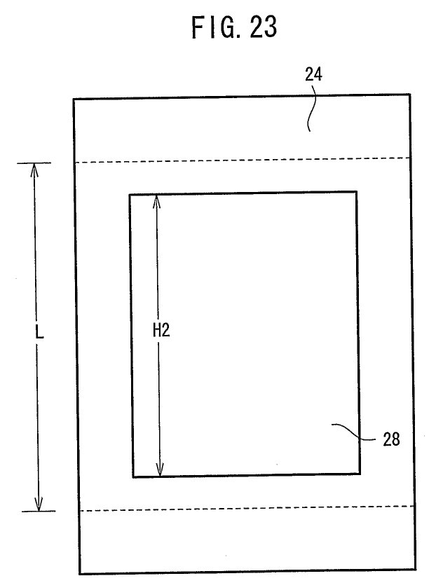

If the length H2 of the photosensitive resin layer 28 which is detected by the detecting mechanism 47a is smaller than the normal length H, as shown in FIG. 23, then the photosensitive resin layer 28 is applied centrally to the glass substrate 24 such that the opposite ends of the photosensitive resin layer 28 is spaced equal distances inwardly from the ends of the applied length L. In this case, a target displacement of the applied position of the photosensitive resin layer 28 is about one-half the displacement that occurs if the opposite ends of the photosensitive resin layer 28 is not spaced equal distances inwardly from the ends of the applied length L.

According to the second embodiment, furthermore, the partly cut regions 34 are formed in the photosensitive web 22 unreeled from the reel-out mechanism 32, and then the protective film 30 is peeled off, leaving the residual sections 30b, after which the photosensitive web 22 is laminated onto the glass substrate 24 to transfer the photosensitive resin layer 28, and then the base films 26 and the residual sections 30b are peeled off by the base peeling mechanism 124, thereby manufacturing the photosensitive laminated body 106. The photosensitive laminated body 106 can be manufactured easily automatically.

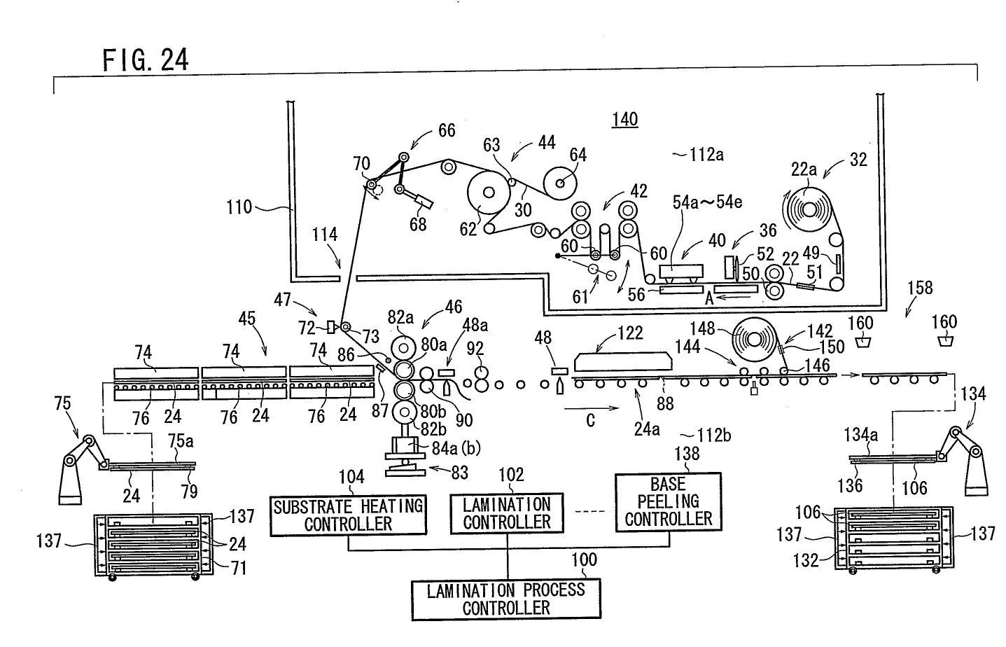

FIG. 24 schematically shows in side elevation a manufacturing apparatus 140 according to a third embodiment of the present invention. Those parts of the manufacturing apparatus 140 according to the third embodiment which are identical to those of the manufacturing apparatus 20 according to the first embodiment are denoted by identical reference characters, and will not be described in detail below.

The manufacturing apparatus 140 includes the inter-substrate web cutting mechanism 48 which is usually not used except for cutting off the photosensitive web 22 in case of trouble and separating the photosensitive web 22 to discharge defective sections. The manufacturing apparatus 140 has a cooling mechanism 122 and an automatic base peeling mechanism 142 which are disposed downstream of the web cutting mechanism 48a. The automatic base peeling mechanism 142 serves to continuously peel off elongate base films 26 by which glass substrates 24 spaced at given intervals are joined together. The automatic base peeling mechanism 142 has a prepeeler 144, a peeling roller 146 having a relatively small diameter, a takeup roll 148, and an automatic joining unit 150.

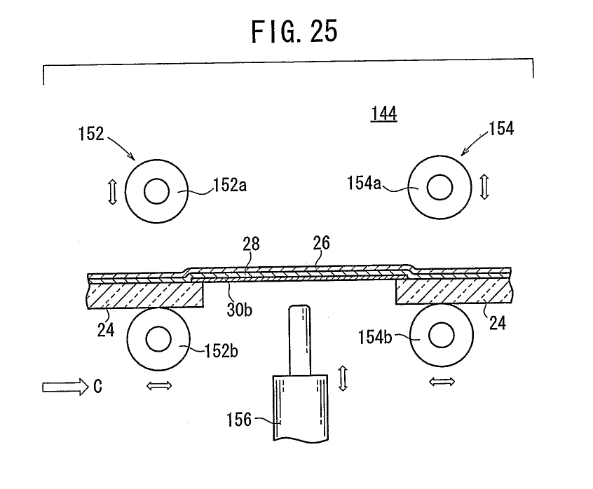

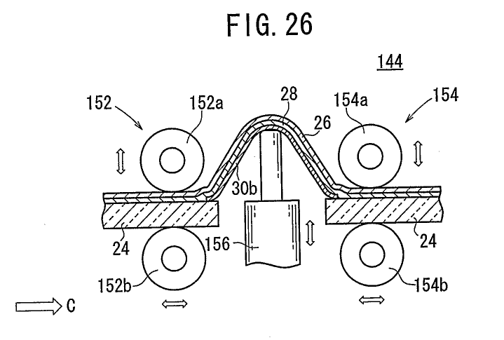

As shown in FIGS. 25 and 26, the prepeeler 144 has a pair of nip roller assemblies 152, 154 and a peeling bar 156. The nip roller assemblies 152, 154 are movable toward and away from each other in the direction in which glass substrates 24 are fed. The nip roller assemblies 152, 154 have vertically movable upper rollers 152a, 154a and lower rollers 152b, 154b. When the upper rollers 152a, 154a are lowered, the upper rollers 152a, 154a and the lower rollers 152b, 154b grip glass substrates 24 therebetween. The peeling bar 156 is vertically movable between adjacent glass substrates 24. The upper rollers 152a, 154a may be replaced with presser bars or presser pins.

The photosensitive web 22 is reheated to a temperature in the range from 30° C. to 120° C. by the peeling roller 146 or at a position immediately before the peeling roller 146. When the photosensitive web 22 is thus reheated, a color material layer is prevented from being peeled off therefrom when the base film 26 is peeled off, so that a high-quality laminated surface can be produced on the glass substrates 24. The reheating may be performed by the peeling roller 146 that also functions as a heating roller such as a roller heated by hot water therein. Alternatively, the reheating may be performed by a separate bar heater or IR heater.

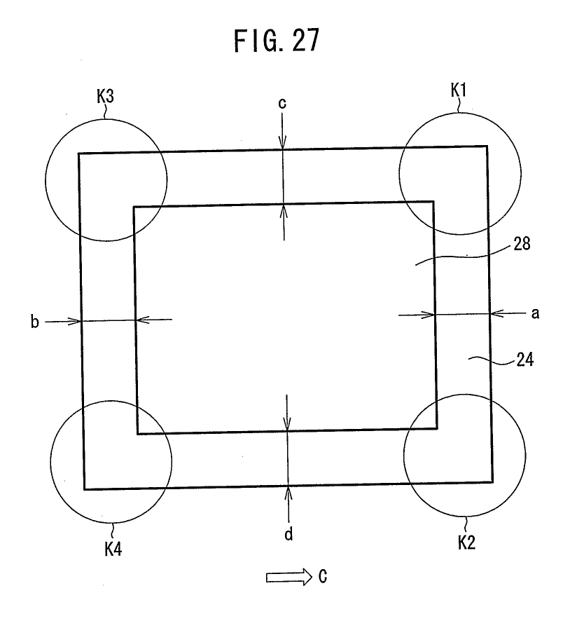

The automatic base peeling mechanism 142 is followed downstream by a measuring unit 158 for measuring the area of a photosensitive resin layer 28 that is actually joined to a glass substrate 24. The measuring unit 158 has a plurality of spaced cameras 160 each comprising a CCD or the like. As shown in FIG. 27, the measuring unit 158 has four cameras 160, for example, for capturing the images of four corners K1 through K4 of a glass substrate 24 to which a photosensitive resin layer 28 is joined. Alternatively, the measuring unit 158 may have at least two cameras for capturing the images of each of longitudinal and transverse sides of a glass substrate 24, rather than the four corners K1 through K4 thereof.

The measuring unit 158 may comprise color sensors or laser sensors for detecting end faces of a glass substrate 24 or may comprise a combination of LED sensors, photodiode sensors, or line sensors for detecting end faces of a glass substrate 24. At least two of these sensors should desirably be employed to capture the image of each of the end faces for detecting the linearity of each of the end faces.

Surface inspection units (not shown) may be employed to detect surface defects of photosensitive laminated bodies 106, such as surface irregularities caused by the photosensitive web 22 itself, laminated film density irregularities caused by the manufacturing facility, wrinkles, striped patterns, dust particles, and other foreign matter. When such a surface defect is detected, the manufacturing apparatus 140 issues an alarm, ejects defective products, and manages subsequent processes based on the detected surface defect.

According to the third embodiment, the joined substrate 24a to which the photosensitive web 22 is laminated is cooled by the cooling mechanism 122 and then delivered to the prepeeler 144. In the prepeeler 144, the nip roller assemblies 152, 154 grip the trailing and leading ends of two adjacent glass substrates 24, and the nip roller assembly 152 moves in the direction indicated by the arrow C at the same speed as the glass substrates 24, with the nip roller assembly 154 being decelerated in its travel in the direction indicated by the arrow C.

Consequently, as shown in FIG. 26, the photosensitive web 22 between the glass substrates 24 are flexed between the nip roller assemblies 152, 154. Then, the peeling bar 156 is lifted to push the photosensitive web 22 upwardly, peeling the projecting films 30 off from the trailing and leading ends of the two adjacent glass substrates 24.

In the automatic base peeling mechanism 142, the takeup roll 148 is rotated to continuously wind the base film 26 from the joined substrate 24a. After the photosensitive web 22 is cut off in case of trouble and separated to discharge defective sections, a leading end of the base film 26 on a joined substrate 24a to which the photosensitive web 22 starts being laminated and the trailing end of the base film 26 wound on the takeup roll 148 are automatically joined to each other by the automatic joining unit 150.

The glass substrate 24 from which the base film 26 is peeled off is placed in an inspecting station combined with the measuring unit 158. In the inspecting station, the glass substrate 24 is fixed in place, and the four cameras 160 capture the images of the glass substrate 24 and the photosensitive resin layer 28. The captured images are processed to determine applied positions a through d.

In the inspecting station, the glass substrate 24 may be fed along without being stopped, and transverse ends of the glass substrate 24 may be detected by cameras or image scanning, and longitudinal ends thereof may be detected by timing sensors. Then, the glass substrate 24 may be measured based on the detected data produced by the cameras or image scanning and the sensors.

According to the third embodiment, after the photosensitive web 22 has been laminated onto a glass substrate 24, the photosensitive web 22 between two adjacent joined substrates 24a is not cut off. Rather, while the joined substrates 24a are being pressed by the peeling roller 146, the base film 26 is continuously peeled off from the joined substrates 24a and wound around the takeup roll 148 which is in rotation. Also, the peeled base film 26 is easily processed.

According to the third embodiment, the same advantages as those of the second embodiment are achieved, e.g., the photosensitive laminated body 106 can be manufactured automatically and efficiently. Furthermore, the manufacturing apparatus 140 is simple in structure.

Although certain preferred embodiments of the present invention have been shown and described in detail, it should be understood that various changes and modifications may be made therein without departing from the scope of the appended claims.

1. An apparatus for manufacturing a photosensitive laminated body, comprising:
a web reel-out mechanism for reeling out an elongate photosensitive web comprising a support, a photosensitive material layer disposed on said support, and a protective film disposed on said photosensitive material layer, said protective film having a peel-off section and a residual section;
a processing mechanism for forming a processed region which is transversely severable in said protective film of said elongate photosensitive web which has been reeled out by said web reel-out mechanism, at a boundary position between said peel-off section and said residual section;
a peeling mechanism (44) for peeling said peel-off section off from said elongate photosensitive web, leaving said residual section;
a substrate feed mechanism for feeding a substrate which has been heated to a predetermined temperature to a joining position;
a joining mechanism for positioning said residual section between said substrates and joining an exposed area of said photosensitive material layer from which said peel-off section is peeled off, to said substrate in said joining position, for producing a joined substrate;
a detecting mechanism disposed closely to said joining position, for directly detecting said boundary position of said elongate photosensitive web or a detecting mark disposed on said elongate photosensitive web in association with said boundary position; and
a control mechanism for adjusting a relative position of said boundary position and said substrate win said joining position, based on boundary position information detected by said detecting mechanism.

2. An apparatus according to claim 1, wherein said detecting mechanism is disposed upstream of and closely to said joining position.

3. An apparatus according to claim 1, further comprising a reservoir mechanism disposed between said processing mechanism and said peeling mechanism, for changing speed or state at which said elongate photosensitive web is fed.

4. An apparatus according to claim 1, further comprising a tension control mechanism disposed between said peeling mechanism and said joining mechanism, for applying tension to said elongate photosensitive web.

5. An apparatus according to claim 1, further comprising a cutting mechanism disposed downstream of said joining mechanism, for cutting off said elongate photosensitive web between said substrates.

6. An apparatus according to claim 1, further comprising a support peeling mechanism disposed downstream of said joining mechanism, for peeling said support off from said joined substrate.

7. An apparatus according to claim 1, wherein said joining mechanism comprises:
a pair of rubber rollers which is heated to a predetermined temperature; and
a roller clamp unit for moving one of said rubber rollers back and forth;
said roller clamp unit comprising:
a cylinder for applying a clamping pressure to said one of said rubber rollers; and
a cam movable by an actuator for moving said cylinder back and forth.

8. An apparatus according to claim 1, further comprising a preheating unit disposed upstream of and closely to said joining mechanism, for preheating said elongate photosensitive web to a predetermined temperature.

9. A method of manufacturing a photosensitive laminated body, comprising the steps of:
reeling out an elongate photosensitive web comprising a support, a photosensitive material layer disposed on said support, and a protective film disposed on said photosensitive material layer, said protective film having a peel-off section and a residual section;
forming a processed region which is transversely severable in said protective film of said elongate photosensitive web which has been reeled out, at a boundary position between said peel-off section and said residual section;
peeling said peel-off section off from said elongate photosensitive web, leaving said residual section;
obtaining boundary position information by directly detecting said boundary position of said elongate photosensitive web or detecting a mark disposed on said elongate photosensitive web in association with said boundary position;
feeding a substrate which has been heated to a predetermined temperature to a joining position;
adjusting a relative position of said boundary position and said substrate in said joining position, based on said obtained boundary position information; and
positioning said residual section between said substrates and joining said photosensitive material layer from which said peel-off section is peeled off, to said substrate in said joining position, for producing a joined substrate.

10. A method according to claim 9, wherein said boundary position information is obtained upstream of and closely to said joining position.

11. A method according to claim 9, further comprising the steps of:
intermittently feeding said elongate photosensitive web through said processing mechanism; and
thereafter, continuously feeding said elongate photosensitive web through reservoir mechanism, in a peeling mechanism and subsequently thereto.

12. A method according to claim 9, further comprising the step of applying tension to said elongate photosensitive web between said step of peeling said peel-off section and said step of joining exposed area of said photosensitive material layers.

13. A method according to claim 9, further comprising the steps of:
cutting off said elongate photosensitive web between said substrates after said step of joining exposed areas of said photosensitive material layer; and
thereafter, peeling said support from said joined substrate to produce a photosensitive laminated assembly.

14. A method according to claim 9, further comprising the step of continuously or intermittently peeling said support from said joined substrate to produce a photosensitive laminated assembly after said step of joining exposed areas of said photosensitive material layer.

15. A method according to claim 9, further comprising the step of preheating said elongate photosensitive web to a predetermined temperature before said step of joining exposed areas of said photosensitive material layer.
